(19) United States
(12) Patent Application Publication
(10) Pub. No.: US 2023/0094429 A1
(43) Pub. Date: Mar. 30, 2023

(54) CARTRIDGE AND LIQUID HANDLING DEVICE

(71) Applicant: Enplas Corporation, Saitama (JP)

(72) Inventor: Nobuya SUNAGA, Saitama (JP)

(21) Appl. No.: 17/449,466

(22) Filed: Sep. 30, 2021

(51) Int. Cl. B01L 3/00

(52) U.S. Cl. CPC B01L 3/502715; B01L 3/50273; B01L 3/502738; B01L 2200/027; B01L 2400/0644

(57) ABSTRACT

A cartridge of the present invention is to be used in combination with a channel chip including a channel through which a liquid flows. The cartridge includes a reservoir for storing a liquid, in which a through hole configured to be connected to the channel is opened into a bottom part of the reservoir; a liquid discarding part for discarding the liquid in the reservoir; and a connection part which is disposed above the through hole, and connects the reservoir and the liquid discarding part to each other.

### TECHNICAL FIELD

The present invention relates to a cartridge and a liquid handling device.

### BACKGROUND ART

In recent years, channel chips and the like have been used to analyze, for example, cells, proteins, and nucleic acids. Channel chips have the advantage of requiring only small amounts of reagents and samples for analysis, and are expected to be used in various applications such as clinical, food, and environmental testing.

Patent Literature (hereinafter, referred to as PTL) 1 describes a nucleic acid analyzer including a stage, a nucleic acid extraction part, a fluorescence detection part, and a controller. The nucleic acid analyzer is used with a cartridge attached thereto. The cartridge includes a plurality of chambers, and the plurality of chambers are connected to each other through a channel.

In the nucleic acid analyzer described in PTL 1, the controller continuously performs treatment by moving a sample and a liquid for the treatment between the plurality of chambers.

### CITATION LIST

### Patent Literature

PTL 1

US Patent Application Publication No. 2020/0078787

### SUMMARY OF INVENTION

### Technical Problem

In the nucleic acid analyzer described in PTL 1, a liquid such as a treatment liquid or a waste liquid (effluent) after the reaction moves back and forth in the channel, thus a residual waste liquid or treatment liquid may be disadvantageously mixed with the reaction liquid.

An object of the present invention is to provide a cartridge capable of discarding a waste liquid stored in a reservoir without allowing the waste liquid to flow into a channel. Another object of the present invention is to provide a liquid handling device including the cartridge.

### Solution to Problem

A cartridge of the present invention is to be used in combination with a channel chip including a channel through which a liquid flows. The cartridge includes a reservoir for storing a liquid, in which a through hole configured to be connected to the channel is opened into a bottom part of the reservoir; a liquid discarding part for discarding the liquid in the reservoir; and a connection part that is disposed above the through hole and connects the reservoir and the liquid discarding part to each other.

A liquid handling device of the present invention includes the cartridge of the present invention; and a channel chip to which the cartridge is to be attached, in which the channel chip includes a channel connected to the through hole, and the channel is configured to allow a liquid flowing inside to move to the reservoir.

### Advantageous Effects of Invention

The present invention can discard a waste liquid stored in a reservoir without allowing the waste liquid to flow into a channel.

### BRIEF DESCRIPTION OF DRAWINGS

FIG. 1 is a schematic cross-sectional view of a liquid handling system according to an embodiment of the present invention;

FIGS. 2A to 2C illustrate a liquid handling device and a chip holder;

FIG. 3 is a plan view illustrating the liquid handling device and the chip holder with the cartridge detached therefrom;

FIG. 4 is a bottom view of the channel chip;

FIGS. 5A to 5C illustrate the configurations of a substrate and a film;

FIG. 6 is a perspective view illustrating the configuration of the cartridge;

FIGS. 7A to 7D illustrate the configuration of a main body of a cartridge (hereinafter also referred to as “cartridge body”);

FIGS. 8A and 8B illustrate the configuration of a cap;

FIG. 9 is a perspective view illustrating a first rotary member and a third rotary member;

FIGS. 10A and 10B illustrate the configuration of a second rotary member;

FIGS. 11A and 11B are diagrams for explaining a method for using the liquid handling device;

FIGS. 12A and 12B are diagrams for explaining the method for using the liquid handling device;

FIGS. 13A and 13B are diagrams for explaining the method for using the liquid handling device; and

FIGS. 14A and 14B are diagrams for explaining the method for using the liquid handling device.

### DESCRIPTION OF EMBODIMENTS

Hereinafter, a liquid handling system according to an embodiment of the present invention will be described in detail with reference to the drawings.

Configuration of Liquid Handling System

The present embodiment describes a liquid handling system and a liquid handling device for processing a liquid by using magnetic beads. More specifically, the present embodiment describes a liquid handling system and a liquid handling device for extracting DNA from a liquid containing a sample, such as blood, by using magnetic beads that non-specifically adsorb DNA.

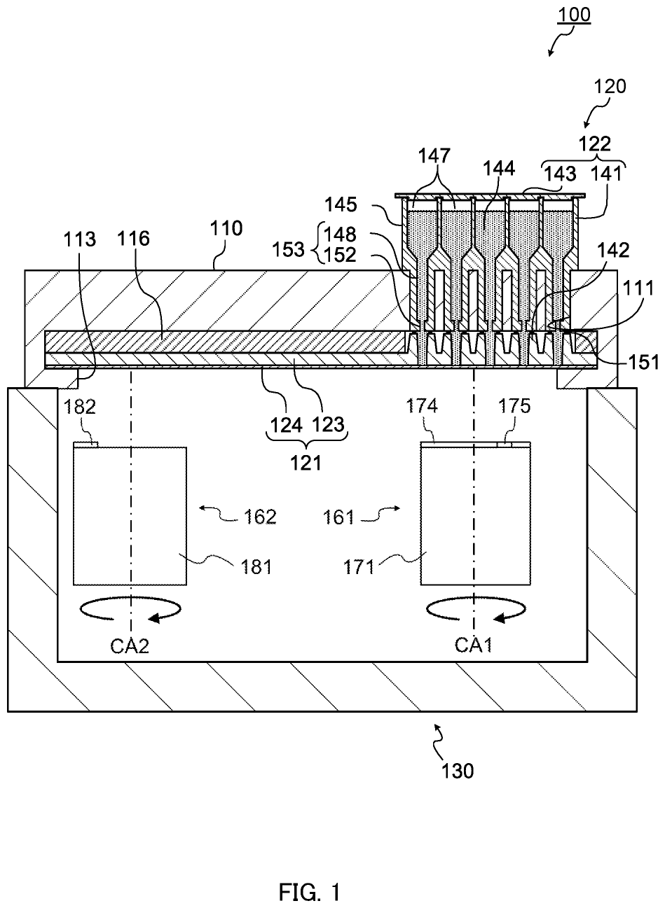

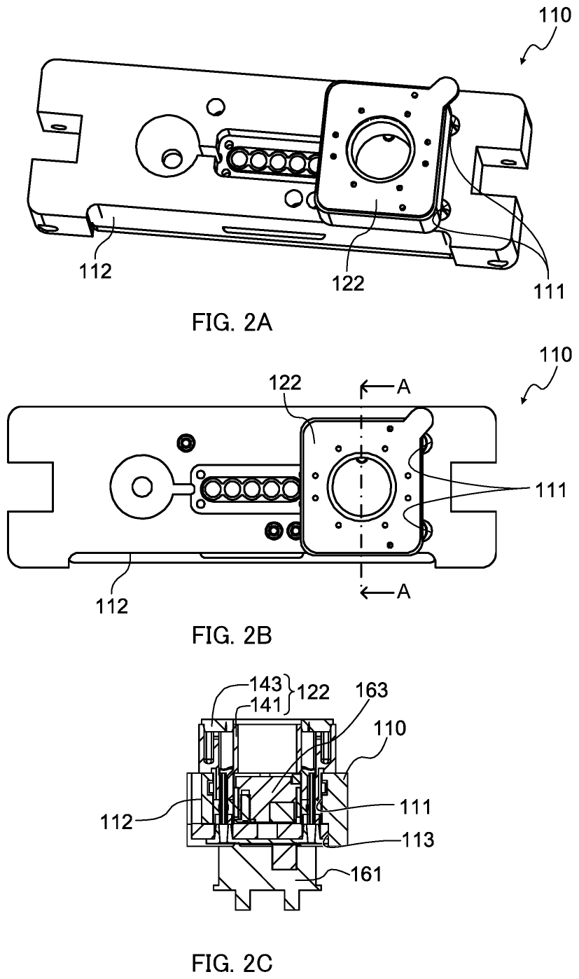

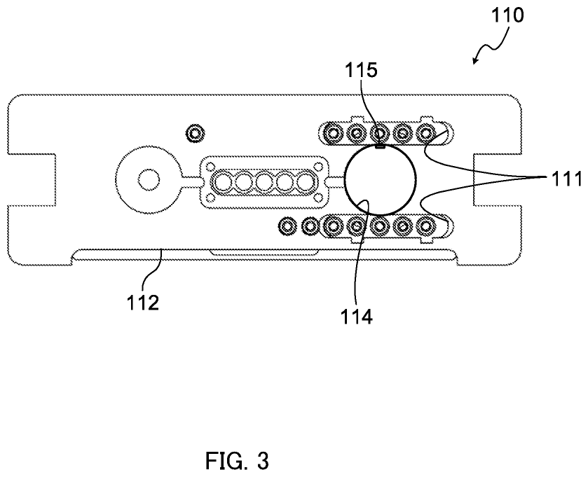

FIG. 1 is a cross-sectional view illustrating the configuration of liquid handling system 100 according to the present embodiment. FIG. 2A is a perspective view illustrating liquid handling device 200 and chip holder 110, FIG. 2B is a plan view illustrating liquid handling device 200 and chip holder 110, and FIG. 2C is a cross-sectional view taken along line A-A of FIG. 2B. FIG. 3 is a plan view illustrating liquid handling device 200 and chip holder 110 with cartridge 122 detached therefrom.

As illustrated in FIG. 1, liquid handling system 100 includes liquid handling device 120, chip holder 110 for holding liquid handling device 120, and liquid controlling device 130. Liquid handling device 120 includes channel chip 121 and cartridge 122. Liquid controlling device 130 includes first rotary member 161, second rotary member 162, and third rotary member 163 which support chip holder 110 and are configured to control a liquid in channel chip 121 housed in chip holder 110.

As illustrated in FIG. 1, FIGS. 2A to 2C, and FIG. 3, chip holder 110 houses channel chip 121 and is disposed at a predetermined position in liquid controlling device 130. In the present embodiment, channel chip 121 is housed in chip holder 110 with plate-shaped spacer 116—for filling the space in chip holder 110—disposed on channel chip 121.

At least one first through hole 111, recess 112, opening 113, and second through hole 114 are formed in chip holder 110.

First through hole 111 is formed in the top surface of chip holder 110, and communication pipes 153 of cartridge 122 are inserted into first through hole 111. In the present embodiment, the number of first through holes is two. In the present embodiment, the size of first through hole 111 when viewed in plan view is sufficiently large to accommodate five communication pipes 153.

Recess 112 is formed in the front surface of chip holder 110 and is used for housing and removing channel chip 121.

Opening 113 is formed in the bottom surface (the surface in contact with film 124 of channel chip 121) of chip holder 110.

Second through hole 114 is formed in the top surface of chip holder 110, and third rotary member 163 is inserted into second through hole 114. Protrusion 115 for restricting the rotation of third rotary member 163 is disposed in second through hole 114. Protrusion 115 may be located at any position. In the present embodiment, protrusion 115 is disposed at a position corresponding to first reservoir 144 (first reservoir 144i).

The shapes of chip holder 110, first through hole 111, recess 112, and opening 113 may be any shapes that allow these components to perform their respective functions.

Configuration of Liquid Handling Device

Liquid handling device 120 includes channel chip 121 and cartridge 122.

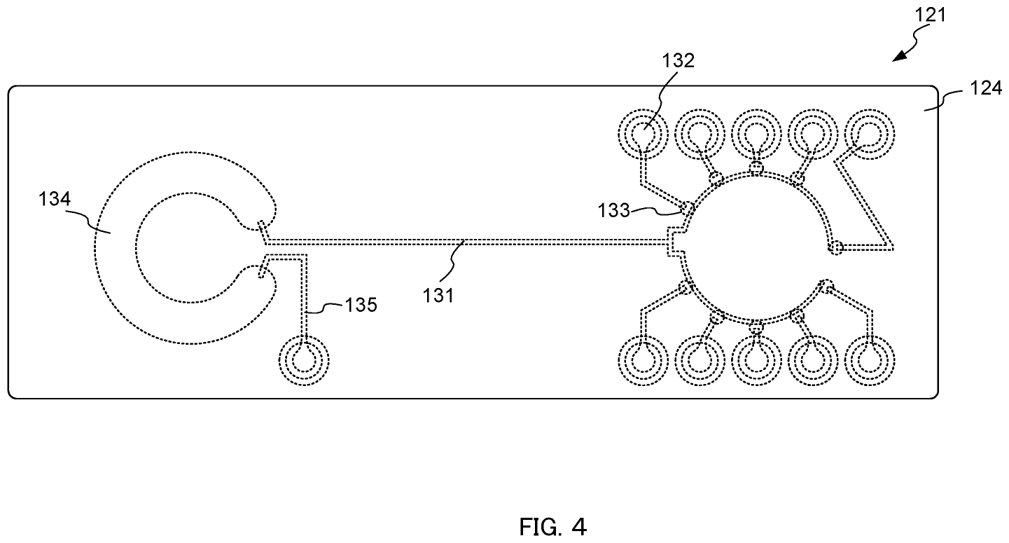

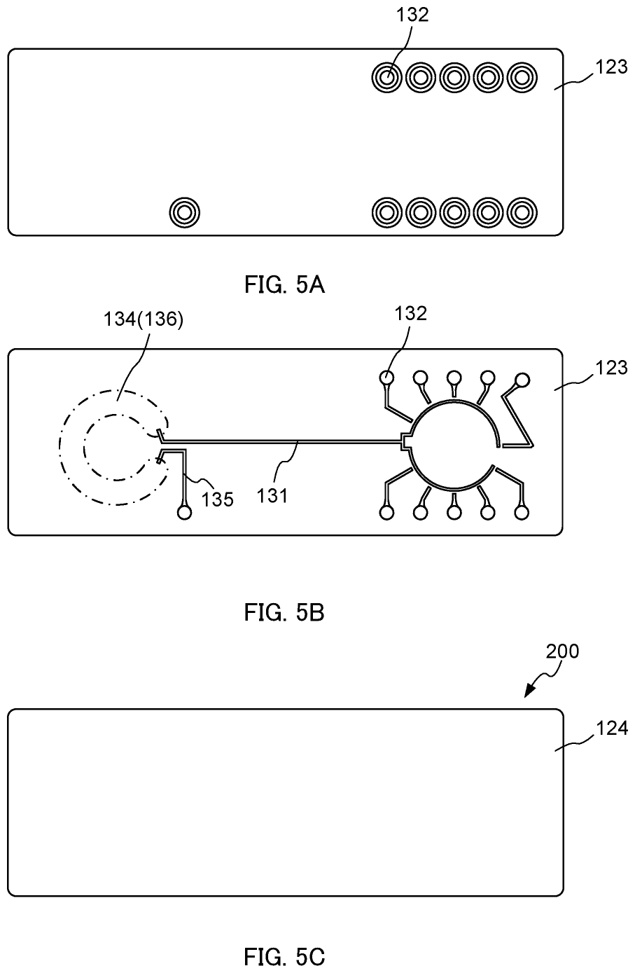

FIG. 4 is a bottom view of channel chip 121. FIG. 5A is a plan view of substrate 123, FIG. 5B is a bottom view of substrate 123, and FIG. 5C is a plan view of film 124.

As illustrated in FIG. 1 and FIGS. 5A and 5B, channel chip 121 includes substrate 123 and film 124. In substrate 123, grooves to serve as channels and a rotary membrane pump, recesses to serve as chambers, and through holes to serve as inlet and outlet ports are formed. Film 124 is joined to one surface of substrate 123 so as to close the openings of the recesses and the through holes formed in substrate 123. A portion of film 124 functions as a diaphragm. The groove in substrate 123, which is closed by film 124, serves as a channel for allowing a liquid such as a reagent, a liquid sample, or a washing liquid to flow through.

Substrate 123 may have any thickness. The thickness of substrate 123 is, for example, 1 mm or more and 10 mm or less. Any material may be used for substrate 123, and can be appropriately selected from, for example, known resins and glass. Examples of the material for substrate 123 include polyethylene terephthalate, polycarbonate, polymethylmethacrylate, polyvinyl chloride, polypropylene, polyether, polyethylene, polystyrene, cycloolefin resins, silicone resins, and elastomers.

Film 124 may have any thickness that allows the film to function as a diaphragm. The thickness of film 124 is, for example, 30 μm or more and 300 μm or less. In addition, film 124 may be made of any material that allows the film to function as a diaphragm. The material of film 124 can be appropriately selected from, for example, known resins. Examples of the material for film 124 include polyethylene terephthalate, polycarbonate, polymethylmethacrylate, polyvinyl chloride, polypropylene, polyether, polyethylene, polystyrene, cycloolefin resins, silicone resins, and elastomers. Film 124 is joined to substrate 123 by, for example, thermal welding, laser welding, and an adhesive.

In the present embodiment, channel chip 121 includes first channel 131, plurality of wells 132 connected to first channel 131, and plurality of valves 133 individually disposed between corresponding wells 132 and first channel 131. The numbers of wells 132 and valves 133 are not limited, and are appropriately set according to the application of channel chip 121.

Well 132 is a bottomed recess for introducing a sample such as blood, a washing liquid, or the like, or discharging a waste liquid or the like. As described above, communication pipe 153 of cartridge 122 is inserted into well 132. In the present embodiment, each recess is composed of a through hole formed in substrate 123 and film 124 that closes one opening of the through hole. The shape and size of each recess are not limited, and can be appropriately set according to the shape of communication pipe 153. Each recess has, for example, a substantially cylindrical shape. Each recess has a width of, for example, 2 mm.

First channel 131 is a channel in which a liquid can move. The upstream ends of first channel 131 are connected to wells 132 at different positions. The downstream end of first channel 131 is connected to rotary membrane pump 134. First channel 131 is composed of grooves formed in substrate 123 and film 124 that closes the openings of the grooves. The cross-sectional area and cross-sectional shape of first channel 131 are not limited. The “cross section of a channel” as used herein means the cross section of the channel orthogonal to the flow direction of the liquid. The cross-sectional shape of the channel is, for example, a substantially rectangular shape having the length of one side (width and depth) of about several tens of micrometers. The cross-sectional area of the channel may be or may not be constant in the flow direction of the liquid. In the present embodiment, the cross-sectional area of the channel is constant.

Plurality of valves 133 are membrane valves (diaphragm valves) individually disposed between first channel 131 and plurality of wells 132, and the valves control the flow of liquids between first channel 131 and wells 132. In the present embodiment, each valve is a rotary membrane valve whose opening and closing is controlled by the rotation of first rotary member 161. In the present embodiment, these valves are disposed on the circumference of one circle whose center is first central axis CAL

Rotary membrane pump 134 is a space formed between substrate 123 and film 124, and the space substantially has a shape of an arc (“C” shape) in plan view. The upstream end of rotary membrane pump 134 is connected to first channel 131, and the downstream end of rotary membrane pump 134 is connected to second channel 135. Second channel 135 is composed of a groove formed in substrate 123 and film 124 that closes the opening of the groove. In the present embodiment, rotary membrane pump 134 is composed of a groove formed in the bottom surface of substrate 123 and film 124 disposed so as to cover the groove. Film 124 disposed to face the groove functions as diaphragm 136. Diaphragm 136 is part of film 124 that is flexible (see FIGS. 5B and 5C). Diaphragm 136 is disposed on the circumference of one circle whose center is second central axis CA2. Alternatively, rotary membrane pump 134 may be composed of the bottom surface of substrate 123 and a diaphragm that faces the bottom surface in such a way that the diaphragm is spaced apart from the bottom surface.

Diaphragm 136 of rotary membrane pump 134 bends to come into contact with substrate 123 when pressed by second protrusion 182 of second rotary member 162. For example, when second protrusion 182 presses diaphragm 136 while sliding from the connection part connected with first channel 131 to the connection part connected with second channel 135 (i.e., counterclockwise in FIG. 5B), a fluid in first channel 131 moves toward rotary membrane pump 134 to create a negative pressure in first channel 131. At the same time, a fluid in rotary membrane pump 134 moves toward second channel 135 to create a positive pressure in second channel 135. On the other hand, when second protrusion 182 presses diaphragm 136 while sliding from the connection part connected with second channel 135 to the connection part connected with first channel 131 (i.e., clockwise in FIG. 5B), a fluid in second channel 135 moves toward rotary membrane pump 134 to create a negative pressure in second channel 135. At the same time, a fluid (for example, air) in rotary membrane pump 134 moves toward first channel 131 to create a positive pressure in first channel 131.

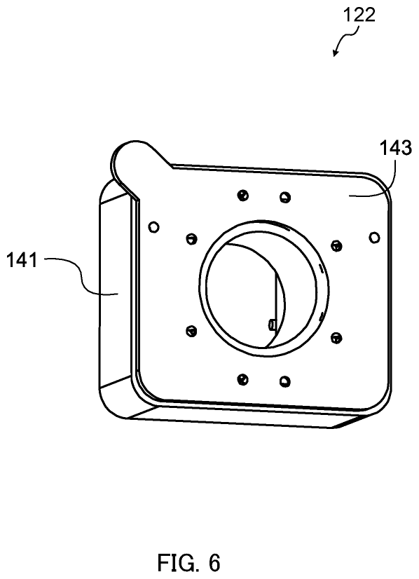

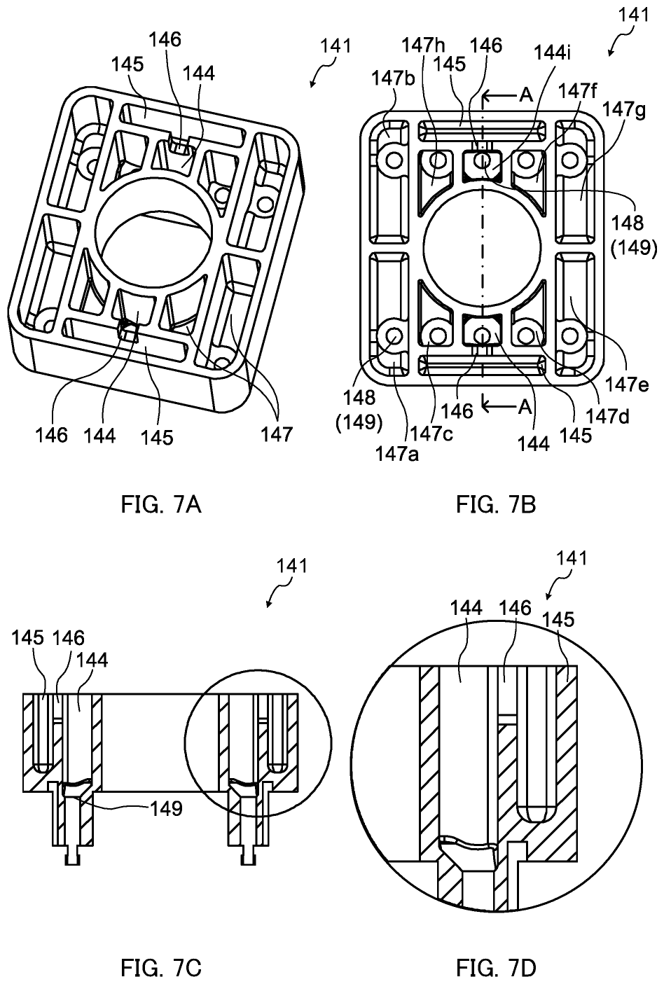

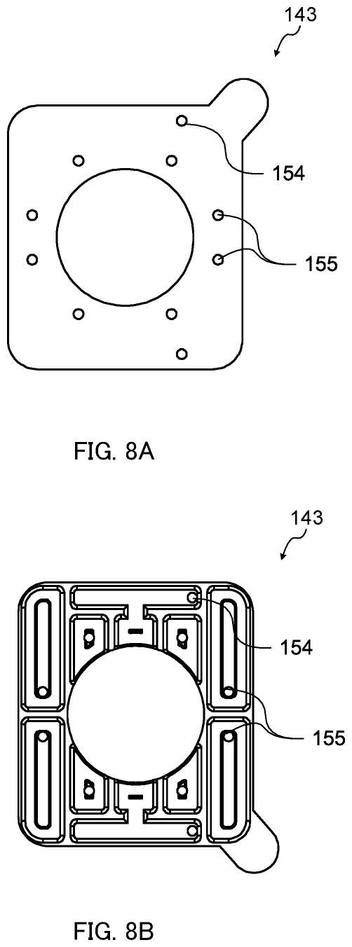

FIG. 6 is a perspective view of cartridge 122. FIG. 7A is a perspective view of cartridge body 141, FIG. 7B is a plan view of cartridge body 141, FIG. 7C is a cross-sectional view taken along line A-A of FIG. 7B, and FIG. 7D is a partially enlarged view of FIG. 7C. FIG. 8A is a plan view of cap 143, and FIG. 8B is a bottom view of cap 143.

As illustrated in FIG. 6, cartridge 122 is configured in such a way that cartridge 122 can be attached to and detached from channel chip 121, and cartridge 122 includes cartridge body 141 and slide part 142 (see FIG. 1). In the present embodiment, cartridge 122 further includes cap 143.

Cartridge body 141 is configured to be slidable with respect to slide part 142. Cartridge body 141 includes at least one first reservoir (reservoir) 144, at least one liquid discarding part 145, and at least one connection part 146. In the present embodiment, cartridge body 141 further includes at least one second reservoir 147 and at least one first communication pipe 148 that is a part of communication pipe 153.

First reservoir 144, liquid discarding part 145, and second reservoir 147 each store liquid. The volumes of first reservoir 144, liquid discarding part 145, and second reservoir 147 are not limited. The volumes of first reservoir 144, liquid discarding part 145, and second reservoir 147 may be the same or different from each other. The numbers of first reservoirs 144, liquid discarding parts 145, and second reservoirs 147 are not limited. In the present embodiment, the number of first reservoirs 144 is two, the number of liquid discarding parts 145 is two, and the number of second reservoir 147 is eight.

In first reservoir 144, second through hole 149 configured to be connected to the channel (first channel 131) is opened at the bottom. In addition, connection part 146 is connected to first reservoir 144.

In liquid discarding part 145, second through hole 149 is not opened at the bottom. Connection part 146 is connected to liquid discarding part 145. In other words, liquid discarding part 145 is connected only to first reservoir 144 via connection part 146.

In second reservoir 147, second through hole 149 configured to be connected to the channel (first channel 131) is opened at the bottom. In addition, connection part 146 is not connected to second reservoir 147. In other words, second reservoir 147 is connected only to the channel (first channel 131) via second through hole 149.

Second through hole 149 opening into first reservoir 144 and second through hole 149 opening into second reservoir 147 may have the same shape or different shapes. In the present embodiment, second through hole 149 opening into first reservoir 144 and second through hole 149 opening into second reservoir 147 have the same shape.

Connection part 146 is disposed above second through hole 149, and connects first reservoir 144 and liquid discarding part 145 to each other. Connection part 146 may have any configuration that can connect first reservoir 144 with liquid discarding part 145. The configuration of connection part 146 may be a notch formed in a partition wall between first reservoir 144 and liquid discarding part 145, or may be a through hole opening at the inner wall surface of first reservoir 144 and at the inner wall surface of liquid discarding part 145. In the present embodiment, connection part 146 is a notch formed at the upper end of the partition wall between first reservoir 144 and liquid discarding part 145.

First communication pipe 148 is a part (on the upstream side) of communication pipe 153. The upstream end of first communication pipe 148 is connected to first reservoir 144 or second reservoir 147, and second communication pipe 152 is connected to the downstream end of first communication pipe 148 (see FIG. 1).

Slide part 142 includes packing 151 and second communication pipe 152 that is on the downstream side of communication pipe 153, and slide part 142 is configured to be slidable with respect to cartridge body 141 (see FIG. 1). Packing 151 is disposed between well 132 and second communication pipe 152, and connects communication pipe 153 and well 132 to each other.

Second communication pipe 152 is a part (on the packing 151 side) of communication pipe 153. First communication pipe 148 is connected to the upstream end of second communication pipe 152, and packing 151 is disposed at the downstream end of second communication pipe 152 (see FIG. 1).

Communication pipe 153 connects first reservoir 144 or second reservoir 147 to packing 151, regardless of the state of the channel between first reservoir 144 or second reservoir 147 and packing 151, i.e., whether the channel is opened or closed. Communication pipe 153 may be made of any material that is capable of maintaining the connection of first reservoir 144 or second reservoir 147 to packing 151. Examples of the material for communication pipe 152 include silicone, urethane, polytetrafluoroethylene (PTFE), and Tygon (Registered Trademark) which is a polyvinyl chloride resin.

Sliding cartridge body 141 with respect to slide part 142 can open and close the channel between first reservoir 144 or second reservoir 147 and packing 151.

As illustrated in FIGS. 8A and 8B, cap 143 covers first reservoirs 144, liquid discarding parts 145 and second reservoirs 147. Cap 143 includes first vents 154 and second vents 155.

First vent 154 connects liquid discarding part 145 to the outside. In other words, first vent 154 is disposed at the position corresponding to the opening of liquid discarding part 145, and is not disposed at the position corresponding to first reservoir 144. First vent 154 when viewed in plan view may have any size that is smaller than that of the opening of liquid discarding part 145 when viewed in plan view. In addition, first vent 154 is preferably disposed at a position far from connection part 146 when cap 143 is attached to cartridge body 141. As described below in detail, disposing first vent 154 at a position far from connection part 146 can properly discharge a liquid from first reservoir 144 to liquid discarding part 145.

Second vent 155 connects second reservoir 147 to the outside. In other words, second vent 155 is disposed at the position corresponding to the opening of second reservoir 147. Second vent 155 when viewed in plan view may have any size that is smaller than that of the opening of second reservoir 147 when viewed in plan view.

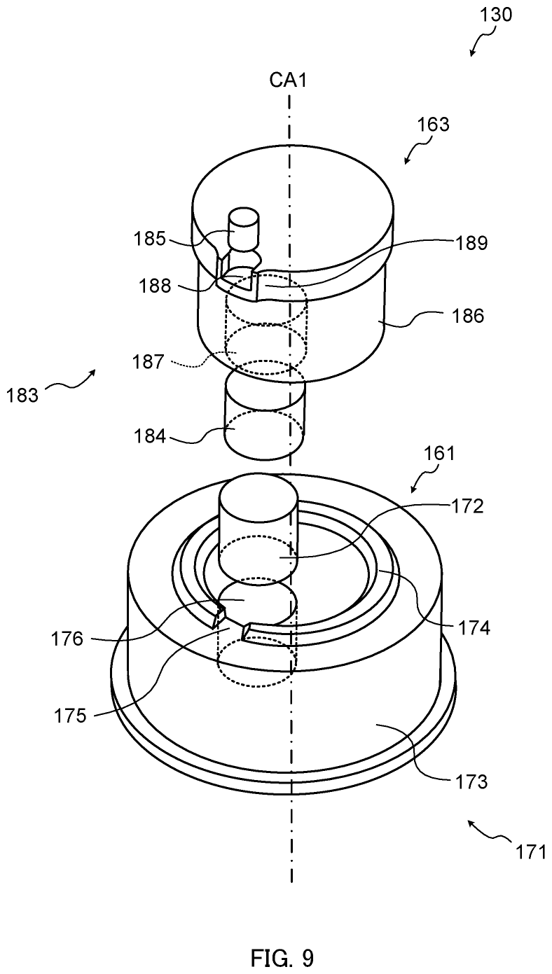

FIG. 9 is a perspective view illustrating first rotary member 161 and third rotary member 163.

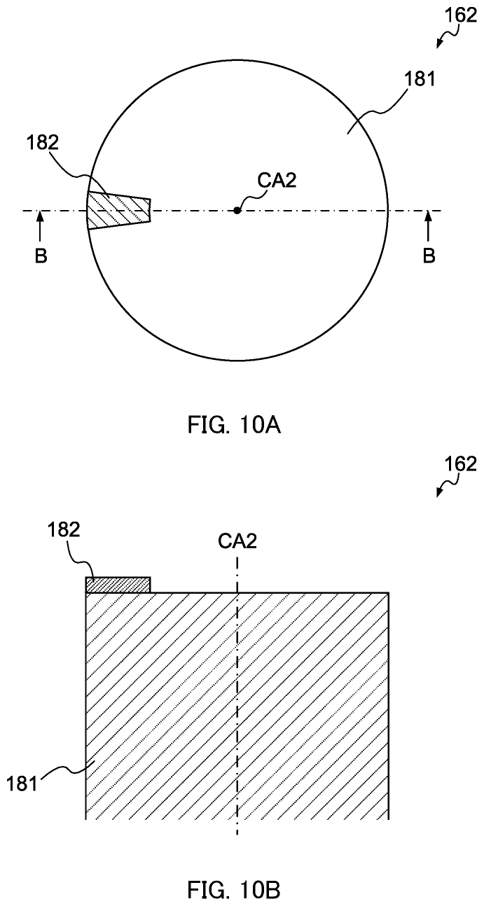

FIG. 10A is a plan view of second rotary member 162, and FIG. 10B is a cross-sectional view taken along line B-B of FIG. 10A.

Liquid controlling device 130 includes first rotary member 161, second rotary member 162, and third rotary member 163.

As illustrated in FIG. 9, first rotary member 161 includes main body 171 of the first rotary member (hereinafter also referred to as “first rotary member body”) and first magnet 172. First rotary member body 171 includes first main body 173 having a cylindrical shape, first protrusion 174 disposed on the top surface of first main body 173, first recess 175, and first disposition part 176. First rotary member body 171 is rotated about first central axis CA1 by a drive mechanism (not illustrated) with first magnet 172 attached to first disposition part 176.

First main body 173 includes, as disposed in the upper portion thereof, first protrusion 174 for pressing the diaphragm of valve 133 to close valve 133, first recess 175 for opening the valve by not pressing the diaphragm, and first disposition part 176 for disposing first magnet 172 therein. First protrusion 174 and first recess 175 are disposed on the circumference of a circle whose center is first central axis CAE In the present embodiment, the shape of first protrusion 174 in plan view is a shape of an arc (“C” shape) corresponding to a part of the circle whose center is first central axis CAE The region on the circumference where first protrusion 174 is not present is first recess 175.

In first disposition part 176, first magnet 172 for moving third rotary member 163 by applying a magnetic field to second magnet 184 of third rotary member 163 is disposed. First magnet 172 may have any size and shape that allow first magnet 172 to generate a magnetic field capable of moving below-described third magnet 185 together with third rotary member 163. The position of first magnet 172 in first main body 173 is appropriately set according to the position of second magnet 184. In the present embodiment, first magnet 172 is disposed in such a way that the distance between first central axis CA1 and the center of first magnet 172 is the same as the distance between first central axis CA1 and the center of second magnet 184.

As illustrated in FIGS. 10A and 10B, second rotary member 162 includes second main body 181 having a cylindrical shape and second protrusion 182 disposed on the top surface of second main body 181. Second main body 181 is rotatable about second central axis CA2. Second rotary member body 181 is rotated by a drive mechanism (not illustrated).

Second main body 181 includes, as provided in the upper portion thereof, second protrusion 182 for operating rotary membrane pump 134 by pressing diaphragm 136 while sliding along the diaphragm. Second protrusion 182 is disposed on the circumference of a circle whose center is second central axis CA2. Second protrusion 182 may have any shape that allows for appropriate operation of rotary membrane pump 134. In the present embodiment, the shape of second protrusion 182 in plan view is a shape of an arc corresponding to a part of the circle whose center is second central axis CA2.

In liquid handling system 100 according to the present embodiment, first protrusion 174 of first rotary member 161 controls the opening and closing of plurality of valves 133 of channel chip 121. For achieving the above control, plurality of valves 133 of channel chip 121 and first protrusion 174 of first rotary member 161 are disposed so as to be positioned on the circumference of the first circle whose center is first central axis CAL

In liquid handling system 100 according to the present embodiment, second protrusion 182 of second rotary member 162 similarly controls the operation of rotary membrane pump 134 of channel chip 121. For achieving the above control, rotary membrane pump 134 of channel chip 121 and second protrusion 182 of second rotary member 162 are disposed so as to be positioned on the circumference of the second circle whose center is second central axis CA2.

As illustrated in FIG. 9, third rotary member 163 includes main body 183 of the third rotary member (hereinafter also referred to as “third rotary member body”), second magnet 184, and third magnet 185. Third rotary member body 183 includes third main body 186 having a substantially cylindrical shape, second disposition part 187 disposed at the bottom surface of third main body 186, and third disposition part 188 disposed at the top surface of third main body 186. Third rotary member 163 is rotated about first central axis CA1 by first rotary member 161 with second magnet 184 disposed in second disposition part 187 and third magnet 185 disposed in third disposition part 188.

In second disposition part 187, second magnet 184 for rotating third rotary member 163 in response to the reception of a magnetic field from first magnet 172 is disposed. Second magnet 184 may have any size and shape that allow second magnet 184 to rotate third rotary member 163 in response to the reception of a magnetic field from first magnet 172. The position of second magnet 184 in third main body 186 is appropriately set according to the position of first magnet 172. In the present embodiment, second magnet 184 is disposed in such a way that the distance between first central axis CA1 and the center of second magnet 184 is the same as the distance between first central axis CA1 and the center of first magnet 172.

In third disposition part 188, third magnet 185 for attracting the magnetic beads that are mixed in the liquid in first reservoir 144 is disposed. Third disposition part 188 includes projection 189. Projection 189 stops the rotation of third rotary member 163 by engaging with protrusion 115 of chip holder 110.

Third magnet 185 may have any size and shape that allow the magnetic beads in first reservoir 144 to be attracted and fixed to third magnet 185. Third magnet 185 in third main body 186 may also be at any position that allows the magnetic beads in first reservoir 144 to be attracted and fixed to third magnet 185. In the present embodiment, third magnet 185 is disposed immediately above second magnet 184. In other words, third magnet 185 is disposed in such a way that the distance between first central axis CA1 and the center of third magnet 185 is the same as the distance between first central axis CA1 and the center of second magnet 184 in the present embodiment.

Operation of Liquid Handling System and Liquid Handling Device

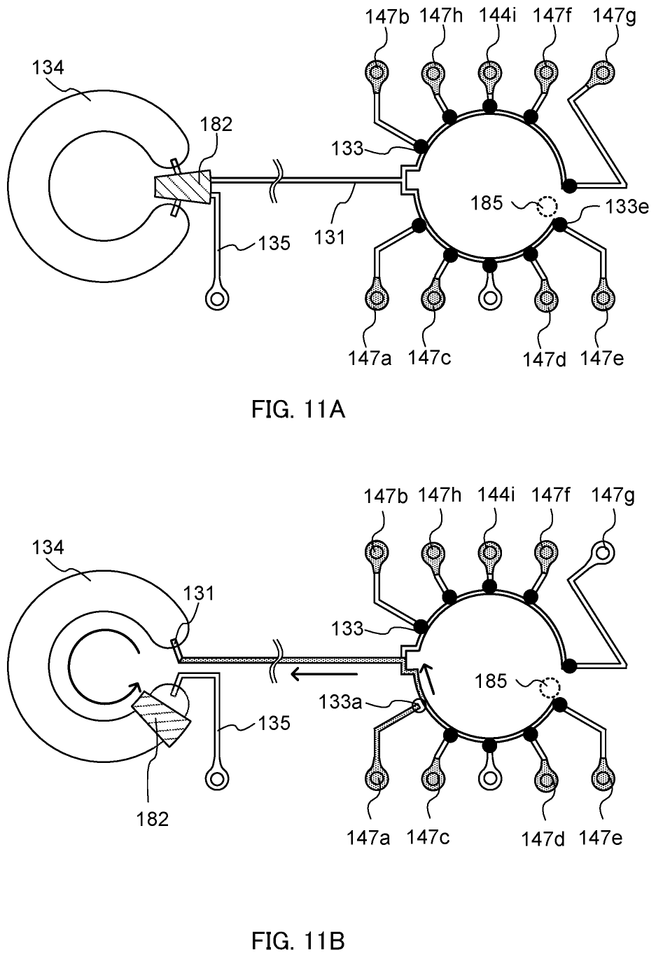

Hereinafter, the operation of liquid handling system 100 and liquid handling device 120 will be described with reference to FIGS. 11A to 14B. Regarding plurality of valves 133 in FIGS. 11A to 14B, when a valve is pressed and closed by first protrusion 174 of first rotary member 161, the valve is indicated by a black circle, and when a valve is not closed, the valve is indicated by an unfilled circle, for convenience of explanation. For each well, the reference numeral of a corresponding reservoir connected to the well is shown in FIGS. 11A to 14B.

As illustrated in FIG. 11A, a sample is introduced into second reservoir 147a, a dissolution liquid is introduced into second reservoir 147b, washing liquids are respectively introduced into second reservoir 147c, second reservoir 147d, second reservoir 147e, and second reservoir 147f, an eluate is introduced into second reservoir 147h, and a magnetic bead dispersion liquid is introduced into first reservoir 144i. At this time, all valves 133 are closed. Further, third magnet 185 is disposed in the vicinity of valve 133e at this time.

As illustrated in FIG. 11B, first rotary member 161 is then rotated to open only valve 133a, and second rotary member 162 is rotated to move the sample in second reservoir 147a to first channel 131.

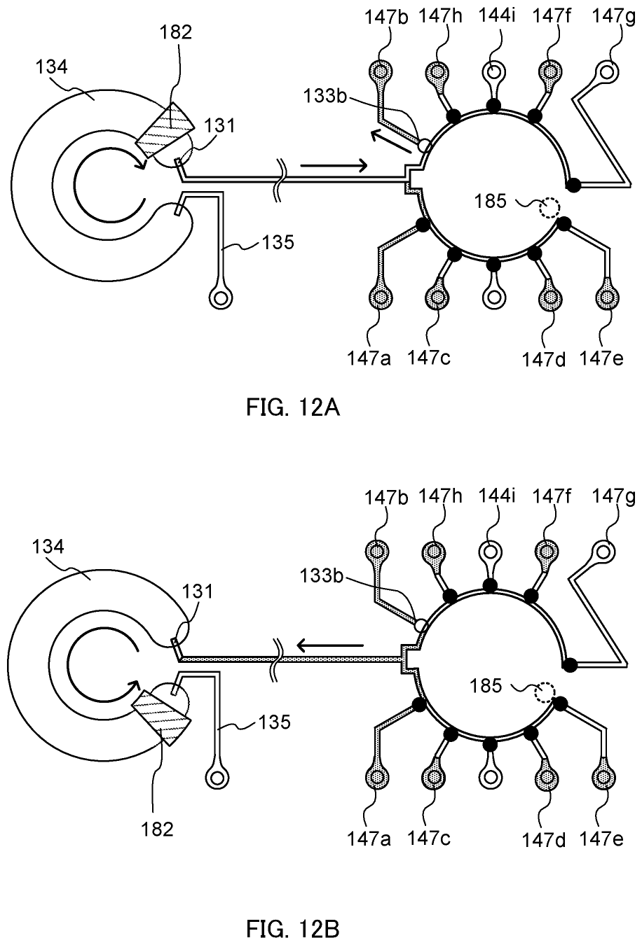

As illustrated in FIG. 12A, first rotary member 161 is then rotated to open only valve 133b, and second rotary member 162 is rotated to move the sample in first channel 131 into second reservoir 147b. Subsequently, second rotary member 162 is rotated as necessary in such a way that the rotation direction of second rotary member 162 is intermittently switched, thereby moving the sample and the dissolution liquid in second reservoir 147b back and forth between second reservoir 147b and first channel 131 to mix the sample and the dissolution liquid. In the mixed solution, the cells contained in the sample are lysed to release DNA.

As illustrated in FIG. 12B, first rotary member 161 is then rotated to open only valve 133b, and second rotary member 162 is rotated to move the mixed solution in second reservoir 147b to first channel 131.

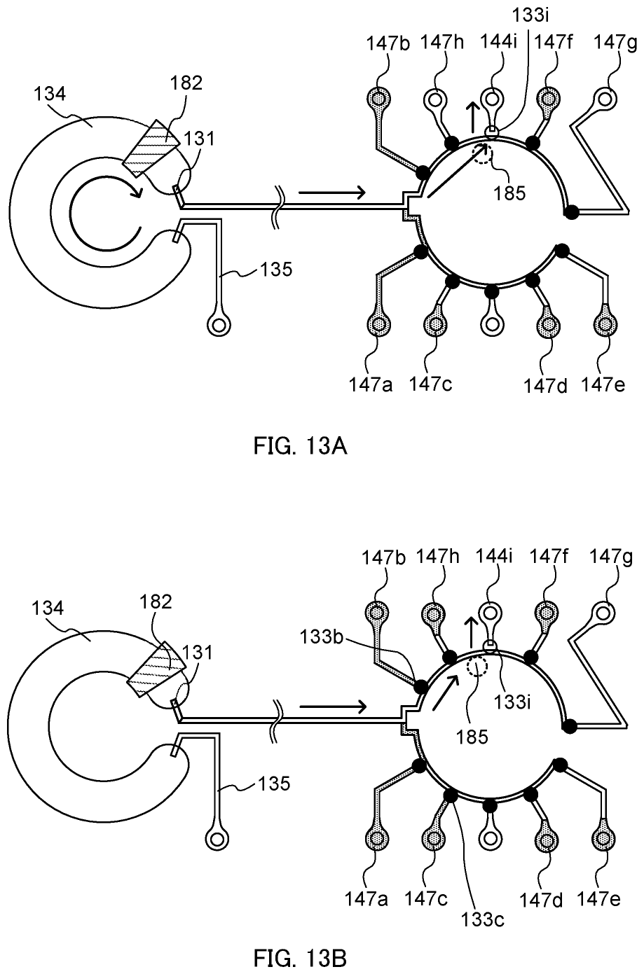

As illustrated in FIG. 13A, first rotary member 161 is then rotated to open only valve 133i, and second rotary member 162 is rotated to move the mixed solution in first channel 131 to first reservoir 144i where magnetic beads are placed. As a result, the DNA adheres to the magnetic beads. Subsequently, second rotary member 162 is rotated as necessary in such a way that the rotation direction of second rotary member 162 is intermittently switched, thereby moving the mixed solution in first reservoir 144i back and forth between first reservoir 144i and first channel 131 to promote contact of the mixed solution with magnetic beads. In this case, first rotary member 161 rotates third rotary member 163 to move third magnet 185 to the vicinity of valve 133i.

As illustrated in FIG. 13B, magnetic beads can be subsequently washed by the following procedure: rotating first rotary member 161 to open only valve 133c, and rotating second rotary member 162 to move the washing liquid in second reservoir 147c into first channel 131; and then rotating first rotary member 161 to open only valve 133i, and rotating second rotary member 162 to move the washing liquid in first channel 131 into first reservoir 144i. The waste liquid of the DNA solution may be discarded to liquid discarding part 145 before the washing liquid is moved. In this case, the following procedure, for example, may be possible: rotating first rotary member 161 to open only valve 133g, and rotating second rotary member 162 to fill first channel 131 with air; and then rotating first rotary member 161 to open only valve 133i, and rotating second rotary member 162 to move the air in first channel 131 into first reservoir 144i. The waste liquid of the DNA solution in first reservoir 144i is discarded to liquid discarding part 145 via second connection part 146.

After washing the magnetic beads with the washing liquid of second reservoir 147c, the same procedure is used to wash the magnetic beads with the washing liquid of second reservoir 147d, to wash the magnetic beads with the washing liquid of second reservoir 147e, and to wash the magnetic beads with the washing liquid of second reservoir 147f in sequence (not illustrated).

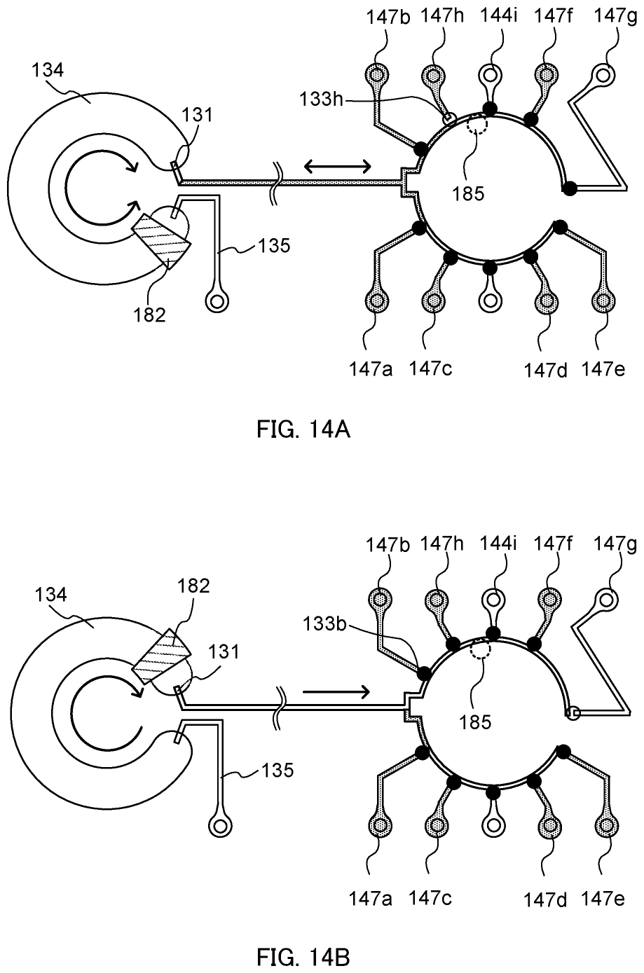

As illustrated in FIG. 14A, first rotary member 161 is then rotated to open only valve 133h, and second rotary member 162 is rotated to move the eluate into first channel 131. Subsequently, first rotary member 161 is rotated to open only valve 133i, and second rotary member 162 is rotated to move the eluate in first channel 131 into first reservoir 144i to mix the eluate and the magnetic beads. This procedure releases the DNA from the magnetic beads.

As the last step, first rotary member 161 is rotated to open only valve 133i, and second rotary member 162 is rotated to move the DNA solution into first channel 131. Subsequently, as illustrated in FIG. 14B, first rotary member 161 is rotated to open only valve 133g, and second rotary member 162 is rotated to move the DNA solution in first channel 131 into liquid discarding part 145g, thereby releasing only the DNA.

The above procedures can treat a liquid with the use of magnetic beads, and more specifically, prepare a DNA extract from a sample with the use of magnetic beads.

Effects

As described above, liquid handling device 100 according to the present embodiment can discard a waste liquid stored in reservoir 144 without allowing the waste liquid to flow into a channel (first channel 131).

### INDUSTRIAL APPLICABILITY

The cartridge and the liquid handling device according to the present embodiment are particularly advantageous for, for example, various applications such as clinical, food, and environmental testing.

### REFERENCE SIGNS LIST

100 Liquid handling system
110 Chip holder
111 First through hole
112 Recess
113 Opening
114 Second through hole
115 Protrusion
116 Spacer
120 Liquid handling device
121 Channel chip
122 Cartridge
123 Substrate
124 Film
130 Liquid controlling device
131 First channel
132 Inlet port
133, 133a, 133b, 133c, 133d, 133e, 133f, 133g, 133h, 133i Valve
134 Rotary membrane pump
135 Second channel
136 Diaphragm
141 Cartridge body
142 Slide part
143 Cap
144, 144i Reservoir
145 Liquid discarding part
146 Connection part
147, 147a, 147b, 147c, 147d, 147e, 147f, 147g, 147h Second reservoir
148 First communication pipe
149 Second through hole
151 Packing
152 Second communication pipe
153 Communication pipe
154 First vent
155 Second vent
161 First rotary member
162 Second rotary member
163 Third rotary member
171 First rotary member body
172 First magnet
173 First main body
174 First protrusion
175 First recess
176 First disposition part
181 Second main body
182 Second protrusion
183 Third main body
183 Third rotary member body
184 Second magnet
185 Third magnet
186 Third main body
187 Second disposition part
188 Third disposition part
189 Projection
260 Rotary membrane pump
CA1 First central axis
CA2 Second central axis

1. A cartridge to be used in combination with a channel chip including a channel through which a liquid flows, the cartridge comprising:
a reservoir for storing a liquid, wherein a through hole configured to be connected to the channel is opened into a bottom part of the reservoir;
a liquid discarding part for discarding the liquid in the reservoir; and
a connection part disposed above the through hole, the connection part connecting the reservoir and the liquid discarding part to each other.

2. The cartridge according to claim 1, further comprising:
a cap that covers the reservoir and the liquid discarding part, wherein
the cap includes a vent that connects the liquid discarding part to an outside.

3. The cartridge according to claim 1, wherein the connection part is a notched groove.

4. The cartridge according to claim 1, wherein the connection part is another through hole.

5. A liquid handling device, comprising:
the cartridge according to claim 1; and
a channel chip to which the cartridge is to be attached,
wherein
the channel chip includes a channel connected to the through hole, and the channel is configured to allow a liquid flowing inside the channel to move to the reservoir.
